(19) United States
(12) Patent Application Publication
(10) Pub. No.: US 2004/0079416 A1
(43) Pub. Date: Apr. 29, 2004

(54) Method and apparatus for metering a fluid

(75) Inventors: Craig Linne, Monroe, MI (US); George Steve Saloka, Dearborn, MI (US); Tony Misovski, Troy, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Motor Company, Dearborn, MI (US)

(21) Appl. No.: 10/065,540

(22) Filed: Oct. 29, 2002

(51) Int. Cl. F16K 31/12

(52) U.S. Cl. 137/487.5

(57) ABSTRACT

An assembly 10 for metering fluid, including an intensifier 12 which selectively receives fluid from a supply 74. The intensifier 12 includes a reciprocally moving plunger 24 which selectively pushes the fluid through the intensifier 12 at a desired flow rate.

### BACKGROUND OF INVENTION

(1) Field of the Invention

The present invention generally relates to a method and an apparatus for metering a fluid and more particularly, to a method and an apparatus for efficiently metering water at a relatively high pressure to a gasoline reformation system.

(2) Background of the Invention

A fluid metering system is typically adapted to selectively provide a certain amount of fluid for use in various applications. Typically, these applications require a relatively precise amount of fluid and oftentimes require the provided fluid to be at a relatively high pressure. For example and without limitation, a gasoline reformation process or application requires a supply of relatively highly pressured water which is later converted into steam, effective to chemically crack the gasoline into constituent carbon material.

While current fluid metering apparatuses do provide relatively precise amounts of fluids, they are relatively costly and complicated, requiring a relatively extensive amount of maintenance and having a relatively high incidence of failure. Moreover, many of these current metering apparatuses do not provided relatively high pressure fluids, thereby being operationally unacceptable for use in many applications.

There is therefore a need for a fluid metering apparatus and a method for metering fluid which utilizes this apparatus and which is adapted to selectively provide relatively highly pressurized fluid in a cost effective manner and which comprises a relatively un-complicated architecture which allows the apparatus to be relatively easily constructed and maintained.

### SUMMARY OF INVENTION

It is a first non-limiting advantage of the present invention to provide a method and an apparatus for metering fluid which overcomes some or all of the previously delineated drawbacks of prior fluid metering methods and apparatuses.

It is a second non-limiting advantage of the present invention to provide a method and an apparatus for metering fluid which overcomes some or all of the previously delineated disadvantages of prior fluid metering methods and apparatuses and which, by way of example and without limitation, selectively meters relatively precise amounts of fluid.

It is a third non-limiting advantage of the present invention to provide a method and an apparatus for metering fluid which overcomes some or all of the previously delineated disadvantages of prior fluid metering methods and apparatuses and which, by way of example and without limitation, selectively meters relatively precise amounts of fluid in an efficient, relatively uncomplicated, and cost efficient manner.

According to a first aspect of the present invention, a fluid metering apparatus is provided. The fluid metering apparatus includes an intensifier which receives fluid and which selectively emits the fluid at a certain pressure; and a regulator which is coupled to the intensifier and which receives and outputs the fluid which is emitted from the intensifier while regulating the pressure of the provided fluid.

According to a second aspect of the present invention, a method for dispensing fluid is provided. The method includes the steps of receiving the fluid; moving the fluid through a small orifice; and regulating the pressure of the fluid which is output from the small orifice.

These and other features, aspects, and advantages of the present invention will become apparent from a reading of the following detailed description of the preferred embodiment of the invention and by reference to the following drawings.

### BRIEF DESCRIPTION OF DRAWINGS

FIG. 1 is a block diagram of a fluid metering apparatus which is made in accordance with the teachings of the preferred embodiment of the invention; and

FIG. 2 is a flow chart comprising a methodology which is used to operate the apparatus which is shown in FIG. 1.

### DETAILED DESCRIPTION

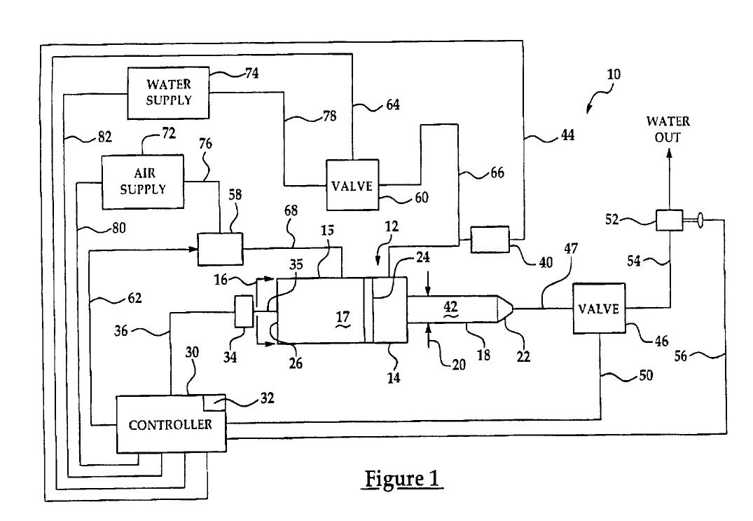

Referring now to FIG. 1, there is shown a fluid metering apparatus 10 which is made in accordance with the teachings of the preferred embodiment of the invention.

As shown, apparatus or assembly 10 includes an intensifier 12 which comprises, in one non-limiting embodiment, a hollow and elongated member 14 having a first portion 15 of a first relatively wide width 16 and a hollow interior 17, and a second portion 18 having a body of a relatively narrow width, a hollow interior 42, and an end 22. In one non-limiting embodiment, end 22 is generally tapered, the width of end 22 being no greater than one-eighth of the width of portion 15. Intensifier 12 further includes a plunger 24 which movably resides within the interior 17 of portion 15 and which is selectively movable from a first position in which the plunger 24 resides against the back wall 26 of the portion 15 to a second position proximate to the second portion 18. Hence, plunger 24 selectively and reciprocally moves or resides within the hollow interior 17 of body portion 15 in a manner which is more fully delineated below.

Apparatus or assembly 10 further includes a controller 30 which is operable under stored program control and which includes at least one “look up table” or memory portion 32. Moreover, apparatus or assembly 10 include a position transducer 34 which is communicatively coupled to the plunger 24 by the use of conduit 35 and which is further physically and communicatively coupled to the controller 30 by use of bus 36.

Apparatus or assembly 10 further includes a pressure transducer 40 which communicates with the interior 42 of the portion 18, by the use of conduit 66, and which is physically and communicatively coupled to the controller 30 by the use of bus 44. Apparatus or assembly 10 also includes a valve 46 which communicates with the interior 42, by the use of conduit 47, and which is communicatively and controllably coupled to the controller 30 by the use of bus 50. Apparatus or assembly 10 further includes a backpressure regulator assembly 52 which is communicatively coupled to the valve 46 by conduit 54 and which is communicatively and controllably coupled to the controller 30 by the use of bus 56. Assembly or apparatus 10 further includes valves 58 and 60 which are respectively, communicatively, and controllably coupled to the controller 30 by the use of busses 62 and 64.

Valve 60 is further communicatively coupled to the pressure transducer 40 and to the interior 17 of portion 15 by the use of conduit 66. Valve 58 is communicatively coupled to the interior 17 of portion 15 by the use of conduit 68. Valves 58 and 60 are adapted to be respectively, selectively, and communicatively attached to a supply of air 72 and a supply of water 74 by the use of respective conduits 76, 78. Moreover, the air supply 72 and the water supply 74 are respectively and controllably coupled to the controller 30 by the use of busses 80 and 82.

Generally, upon receipt of a certain desired output flow rate, the controller 30 generates and places a first signal on the bus 80 and a second signal on the bus 82 which are respectively effective to enable or activate the air supply 72 and the water supply 74. Then the controller 30 generates and transmits a third signal on the bus 62 and a fourth signal on the bus 64, effective to respectively control the pressure of the air entering interior portion 17 and the rate at which the water flows into the interior portion 17. The received air causes the plunger 24 to move from the first position toward the portion 18, thereby operatively forcing the received water through the interior portion 17 and into the interior portion 42, effective to cause the received water to be emitted from the end portion 22 and communicated to the valve 46. Before the pressurized water reaches the valve 46, the controller 30 generates and places a fifth signal onto bus 50, effective to cause the valve 46 to be opened by a certain amount, thereby allowing the water to be emitted through conduit 54 and through the regulator assembly 52 at the certain desired output flow rate.

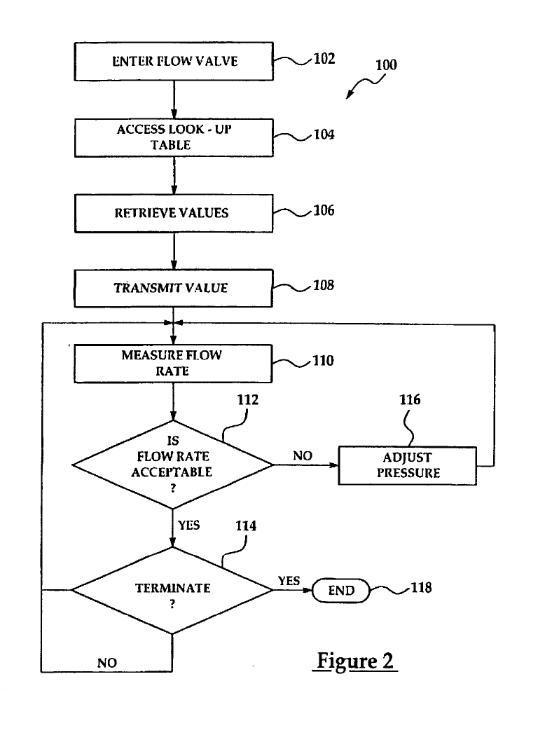

Regulator assembly 52 is selectively activated or controlled by the use of signals placed onto bus 56 by the controller 30. When selectively activated, the regulator 52 “regulates” the pressure of the water, by allowing water to be emitted at a constant pressure at the desired flow rate as the plunger 24 is retracted. After all of the fluid has been emitted from the intensifier 12, the valves 58, 60 are deactivated by controller 30, thereby preventing air and water from entering the first portion and causing the plunger to return to the first position (i.e., against back wall 26). If more water is to be emitted, the valves 58, 60 are reactivated or enabled. The operation of the flow metering assembly or apparatus 10 will now be more specifically explained with respect to flowchart or methodology 100 which is delineated within FIG. 2.

As shown, methodology or flowchart 100 begins with an initial step 102 in which a certain desired flow value is created and communicated to the controller 30. In another non-limiting embodiment of the invention, both the desired flow rate and the desired pressure of the emitted water is supplied to the controller 30. Step 104 follows this step 102 and, in step 104, controller 30 uses the received flow value to access the look up table or memory 32.

That is, in the preferred embodiment of the invention, the apparatus or assembly 10 is initially calibrated at several rates of flow and pressures which emanate from the regulator 52 (“output flow rates” and “output pressures”). For each such output flow rate and output pressure rate, the flow rate emanating from the water supplied by the water supply 74 (“the input flow rate”), the pressure supplied by the air supply 72 (“the input pressure”), and the position of the valve 46 is noted. Hence, if a commanded flow is substantially equal to one of the previously calibrated flow values, the noted input pressure, input flow rate, and valve position are used. If a commanded flow rate is not substantially equal to one of the previously calibrated flow values, the required input flow and pressure values are interpolated from the data which has been obtained by calibration in a known and conventional manner.

By way of example and without limitation, in one non-limiting embodiment of the invention, the amount by which the output pressure and output flow rate may change for an incremental change in the position of the valve 46 (assuming a certain constant input flow rate and input pressure), the amount by which the output pressure and the output flow rate may change for an incremental change in the input flow rate (assuming a constant pressure and a constant position of the valve 46), and the amount by which the output pressure and output flow rate may change for an incremental change in the input pressure (assuming a constant input flow rate and a constant position of the valve 46) are stored within memory portion 32. The controller 30, in this non-limiting embodiment, therefore recognizes the differences between the desired output flow rate and output pressure and the measured output flow rate and measured output pressure and uses the foregoing incremental relationships to adjust the input flow rate (by controlling valve 60 in the previously delineated manner), and/or to adjust the input pressure (by controlling valve 58 in the previously delineated manner), and/or to adjust or control the valve 46 in the previously delineated manner, effective to cause the measured output flow rate and the measured output pressure to be substantially and respectively equal to the desired output flow rate and the desired output pressure.

Step 106 follows step 104 and, in this step 106, the foregoing value(s) for the input flow rate, the input pressure, and the position of the valve 46 are retrieved and/or created/interpolated in the foregoing manner. Step 108 follows step 106 and, in this step 108, the foregoing control signals are transmitted to the valves 52, 58, and/or 60. Step 110 follows step 108 and, in this step 110, the output flow rate and/or output pressure is measured.

Step 112 follows step 110 and, in this step 112, the controller 30 determines whether the measured output flow rate and/or the measured output pressure is acceptable (e.g., is within about five percent of the respective desired value). If the measured output pressure and/or flow rate is acceptable, step 112 is followed by step 114. Alternatively, step 112 is followed by step 116 in which the input pressure and/or the input flow rate and/or the position of valve 46 is adjusted. Step 116 is followed by step 110.

In step 114, controller 30 determines whether methodology 100 is to terminate (e.g., a certain time period has elapsed, a termination signal has been received, or a certain amount of water has been delivered). If such termination is desired or required, step 114 is followed by step 118 in which methodology 100 is terminated. Alternatively, step 114 is followed by step 110.

It is to be understood that the invention is not limited to the exact construction or methodology which has been delineated above, but that various changes and modifications may be made without departing from the spirit and the scope of the inventions as are delineated in the following claims. Importantly, it should be appreciated that the forgoing apparatus 10 has a relatively uncomplicated architecture, is relatively easy to maintain, and is very cost effective. Further, it should be appreciated that the emitted water may be used in a gasoline reformation process and that other fluids (e.g., fluids other than water) may be used within the system or apparatus 10.

1) a fluid metering apparatus comprising an intensifier which receives fluid and which selectively emits the fluid at a certain pressure; and a regulator which is coupled to the intensifier and which receives and outputs the fluid which is emitted from the intensifier while regulating the pressure of the provided fluid:

2) The fluid metering apparatus of claim 1 wherein said intensifier has a first wide portion which initially receives said fluid and a second narrow portion which is in communication with said first wide portion and which includes a tapered end through which said fluid is emitted.

3) The fluid metering apparatus of claim 2 further comprising a plunger which is selectively movable within said first portion and which selectively pushes said fluid from said first portion to said second portion.

4) The fluid metering apparatus of claim 3 further comprising a transducer which senses the position of said plunger and which generates a signal which is representative of said sensed position.

5) The fluid metering apparatus of claim 4 further comprising a first valve which selectively allows air to be communicated into said first portion, effective to cause said plunger to move within said first portion.

6) The fluid metering apparatus of claim 5 further comprising a second valve which selectively allows said fluid to enter said first portion.

7) The fluid metering apparatus of claim 6 wherein said fluid comprises water.

8) The fluid metering apparatus of claim 7 further comprising a controller which is controllably coupled to said first and second valves and to said transducer.

9) A method for dispensing fluid comprising the steps of receiving the fluid; moving the fluid through a small orifice; dispensing said fluid from said small orifice at a certain pressure; and regulating the pressure of the fluid which is output from the small orifice.

10) The method of claim 9 wherein said fluid comprises water.

11) The method of claim 10 wherein said step of receiving said fluid comprises the steps of providing a fluid reception member having a first wide hollow portion and a second narrow portion which is in communication with said first wide hollow portion; and communicatively coupling said first wide hollow portion to said fluid.

12) The method of claim 11 wherein said small orifice has a width which is no greater than about one eighth of said width of said first portion.

13) The method of claim 9 wherein said orifice is tapered.

14) The method of claim 13 wherein said step of dispensing said fluid from said small orifice at a certain pressure comprises the steps of providing a plunger; and reciprocally placing said plunger within said fluid reception member.

15) A method for controlling the dispensation of fluid at a certain desired output flow rate from an apparatus of the type which receives said fluid at a certain input flow rate and which receives pressurized gas at a certain input pressure, said method comprising the steps of:
receiving said desired output flow rate;
defining at least one of said input flow rate and said input pressure by use of said desired output flow rate;
utilizing said at least one defined value;
measuring said output flow rate;
comparing said measured output flow rate with said desired output flow rate; and
altering said at least one defined value based upon said comparison.

16) The method of claim 15 wherein said fluid comprises water.

17) The method of claim 15 wherein said method further comprises the steps of defining a valve position by use of said output flow rate; and utilizing said defined valve position.

18) The method of claim 15 wherein said step of defining at least one of said input flow rate and said input pressure by use of said desired output flow rate comprises the steps of:
providing a plurality of calibrated flow values; and
comparing said desired output flow rate with said calibrated flow values.

19) The method of claim 18 further comprising the step of interpolating said plurality of calibrated flow rates to define said at least one of said input flow rate and said input pressure if said desired flow rate is not substantially equal to any of said plurality of calibrated flow values.
